(19) United States
(12) Patent Application Publication
(10) Pub. No.: US 2005/0110749 A1
(43) Pub. Date: May 26, 2005

(54) Signal generator with display

(75) Inventor: Donald William Metzger, Colorado Springs, CO (US)

Correspondence Address: LAW OFFICE OF DALE B. HALLING, 24 s. WEBER ST., SUITE 311, COLORADO SPRINGS, CO, 80903, US

(73) Assignee: PrecisionWave Corporation

(21) Appl. No.: 10/988,090

(22) Filed: Nov. 12, 2004

Related U.S. Application Data
(60) Provisional application No. 60/524,797, filed on Nov. 25, 2003.

(51) Int. Cl. G09G 5/00

(52) U.S. Cl. 345/156

(57) ABSTRACT

A signal generator has a signal generating system with an output. A control parameter system controls a state of the signal generating system. A graphical display system displays a graphical image associated with the output.

### RELATED APPLICATIONS

The present invention claims priority on provisional U.S. patent application, Ser. No. 60/524,797, filed on Nov. 25, 2003, entitled “Real Time Output Display for RF and Microwave Signal Generators”.

### FIELD OF THE INVENTION

The present invention relates generally to the field of test equipment and more particularly to a signal generator.

### BACKGROUND OF THE INVENTION

Signal generators are used by electrical and electronic engineers to test electronic equipment. Originally, signal generators only had a couple of different settings. For instance, a user could select the frequency, the amplitude and the type of signal. There were three typical types of signals: sine waves, amplitude modulated and frequency modulated signals. As cellular phones and other types of RF (radio frequency) and microwave products became more popular, and the complexity of the signaling schemes they used became more complex, the number of controllable parameters for signal generators increased substantially. Present signal generators use status lights or text messages to let the operator know which parameters have been selected. Unfortunately, even with this feedback, it is often difficult to know if all of the controllable parameters have been correctly set. One solution users have found to this problem is to connect another instrument to the output to verify the signal that is being generated. This is inefficient and time consuming.

Thus, there exists a need for an improved method of showing the output of a signal generator that is more efficient and saves the user time.

### SUMMARY OF INVENTION

A signal generator that overcomes these and other problems has a signal generating system with an output. A control parameter system controls a state of the signal generating system. A graphical display system displays a graphical image associated with the output. The graphical image may be a two dimensional image. The graphical image may show a spectral content. The graphical display system may measure an intermediate frequency of the signal generating system and display the spectral content. The graphical display system may measure the output of the signal generating system and display the spectral content. The spectral content may be calculated. The spectral content may be calculated from the state of the control parameter system. The graphical display system may display an intermediate frequency portion of the signal generating system.

In one embodiment, a signal generator has a signal producing system having an output. A control system controls a state of the signal producing system. A graphical display system displays a multi-dimensional graphical image associated with a radio frequency portion the output. The two dimensional graphical image may be a calculated image of the output of the signal producing system. The calculated image may be a spectral image. The spectral image may be of the output. The spectral image may be of the intermediate frequency. The multi-dimensional may be based on a measurement of a signal of the signal generating system. The signal may be the output of the signal generating system. The signal may be an intermediate frequency of the signal generating system.

In one embodiment, a signal generator has controllable signal producing system having an output signal. A control system controls a state of the controllable signal producing system. A graphical display system displays a measured signal on a multi-dimensional graphical image associated with the output. The multi-dimensional image may be a spectral image. The measured signal may be an intermediate frequency signal. The measured signal may be an output of a modulation system in the controllable signal producing system.

### BRIEF DESCRIPTION OF THE DRAWINGS

FIG. 1 is a block diagram of a signal generator in accordance with one embodiment of the invention;

FIG. 2 is a block diagram of a controllable signal producing system in accordance with one embodiment of the invention;

FIG. 3 is a block diagram of a control system in accordance with one embodiment of the invention; and

FIG. 4 is a block diagram of graphic display system in accordance with one embodiment of the invention.

### DETAILED DESCRIPTION OF THE DRAWINGS

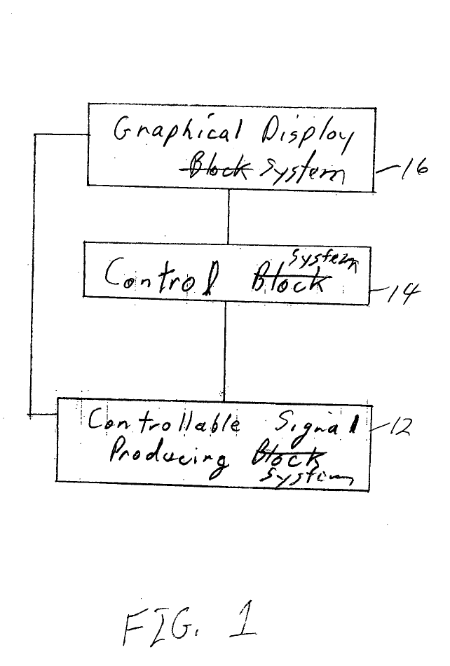

FIG. 1 is a block diagram of a signal generator 10 in accordance with one embodiment of the invention. The signal generator 10 has a controllable signal producing system 12 controlled by a control system 14. The signal producing system 12 has all the electronics necessary to generate an RF (radio frequency) or microwave signal, including a variety of modulation schemes. The control system 14 is coupled to a graphical display system 16. The graphical display system 16 has a two or more dimensional display that shows a graphical representation of the output signal. This allows the user to easily ascertain the characteristics of the signal which has been selected from the signal generator. Unlike previous signal generators, the user is not limited to status lights, on-off indicators, text messages or other one dimensional indicators of the output signal, but a two or more dimensional representation of the output signal is supplied. This reduces errors caused by having incorrect settings, saves the user time, is intuitive and does not require the user to have a second piece of test equipment to view the output signal.

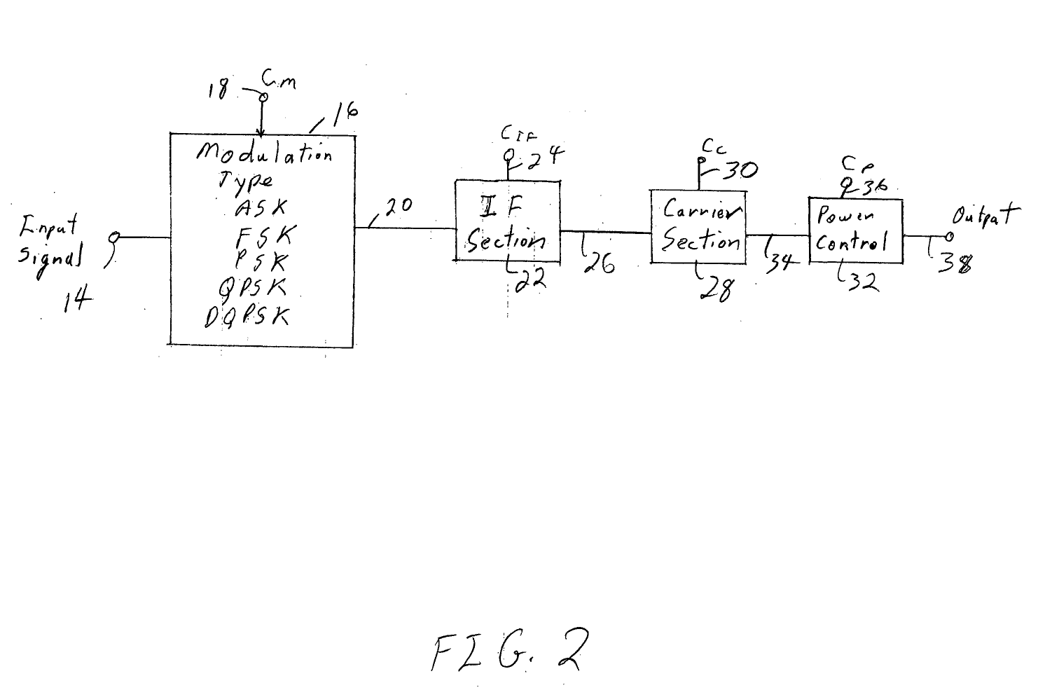

FIG. 2 is a block diagram of a controllable signal producing system 12 in accordance with one embodiment of the invention. The signal producing system 12 has an input 14 for an input signal. The input signal may be encrypted, error encoded, have a spreading code applied, etc. The input signal 16 is then applied to a modulation system 16. The modulation format is selectable by a control input 18. The modulation formats may include AM (Amplitude Modulation), FM (Frequency Modulation), ASK (Amplitude Shift Keying), FSK (Frequency Shift Keying), PSK (Phase Shift Keying), QPSK (Quadrature Phase Shift Keying), DQPSK (Differential Quadrature Phase Shift Keying), etc. The output 20 of the modulation system 16 is coupled to an IF (Intermediate Frequency) section 22. The IF section 22 may include a mixer, a controllable oscillator, a controllable filter, etc. The IF section 22 is controlled by a control signal CIF 24. The control signal 24 may control the oscillator frequency and amplitude. The output 26 of the IF section 22 is coupled to the carrier section 28. The carrier section 28 has a control input 30. The control input 30 may control the carrier frequency. A power control section 32 may be coupled to the output 34 of the carrier section 28. The power control section 32 is controlled by a control signal 36. The control input 36 may control the output power. The output of the power control section 32 is the output RF or microwave signal 38. The IF (intermediate Frequency) section 24, carrier section 28 and power control section 32 are the RF portion of the system 12. The controllable signal producing system 12 can produce a wide variety of signals that are of interest to RF and microwave engineers.

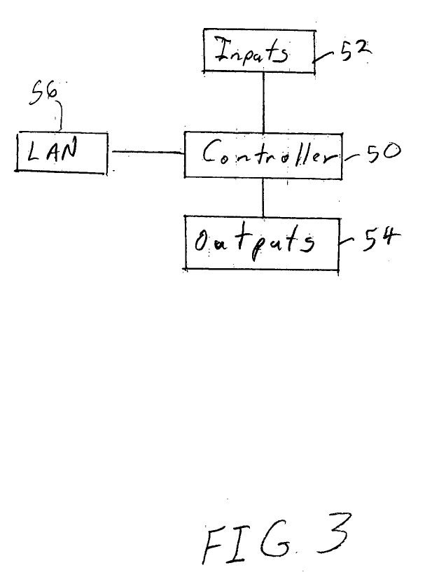

FIG. 3 is a block diagram of a control system 14 in accordance with one embodiment of the invention. The control system 14 has a controller 50. The controller 50 is coupled to a plurality of inputs 52. The inputs 52 may include the type of modulation, the output power, the carrier frequency, etc. These inputs are translated by the controller 50 into the output control signals 54 that are necessary to achieve the desired signal by the signal producing system 12. As a result, the output signals 54 would include the control signals 18, 24, 30 & 36 shown in FIG. 2. The control system 14 may be accessed by a local area network connection 56. This also allows the system to be controlled over local or wide area network. In general, there are five groups of parameters the control system 14 controls. These five groups of parameters are the modulation type, the frequency, the on/off control for the modulation, the power level and the on/off control for the output.

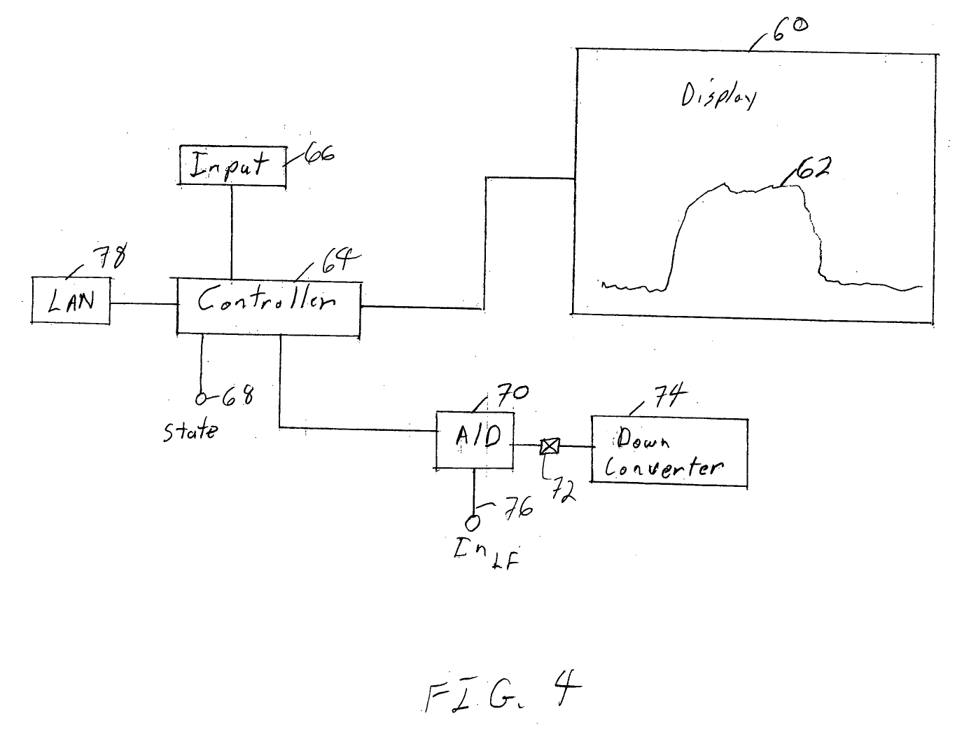

FIG. 4 is a block diagram of graphic display system 16 in accordance with one embodiment of the invention. The graphic display system 16 has a two or more dimensional display 60. The multi-dimensional display 60 provides a standard waveform view 62 of a signal associated with the output signal 38. For instance, the display 60 may show a spectral content or power versus frequency curve that is commonly shown by a spectrum analyzer. This is probably the most useful view for a user to determine if the output signal 38 of the signal generator 10 is the signal the user desires. The display 60 may also show a plot of the in-phase signal versus the quadrature-phase signal. This type of display is helpful to view the inputs when a quadrature modulation scheme is used. The display 60 may also show the in-phase signal versus time or the quadrature-phase signal versus time. Other signals may also be shown on the display 60, such as waterfall displays. The display 60 may show the signals in real time or may update the displayed plot(s) only when a change in the signal generator state has occurred.

The displayed signal 62 may be generated in a number of different manners. The display 60 is coupled to a controller 64. The controller 64 is coupled an input section 66. The input section 66 may be used to define the type of signal 62 the user wants to view. The controller 64 also receives state information 68 from the control system 14. The state information defines all the states of the RF section 12. This state information may then be used by the controller to synthesize the display 62. In one embodiment, the state information may not include the input signal 14 information. The controller 64 may also be coupled to an analog to digital (A/D) converter 70. The A/D converter 70 is coupled through a controllable switch 72 to a RF (microwave) down converter system 74. The A/D converter 70 may also be coupled to low frequency input 76. The A/D converter 70 allows the actual signals generated in the signal producing system 12 to be measured and displayed. The down converter 74 may be necessary if the output signal 38 is directly measured from the RF output rather than an IF output 26. When a spectral plot of the output signal or associated signal is desired, the controller 64 has a Fourier transform capability. The input 76 allows the AND converter to digitize the IF signal output 26, the in-phase input signal, the quadrature-phase input signal, the input data and etc. The images on the display 60 may be accessed by a local area network 78 connection. This may be the same LAN connection as that shown in FIG. 3.

Thus, there has been described a signal generator that is easy to use, saves the user time and does not require additional test equipment to determine the characteristics and state of the output signal of the signal generator.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

1. A signal generator comprising:
a signal generating system having an output;
a control parameter system controlling a state of the signal generating system; and
a graphical display system displaying a graphical image associated with the output.

2. The signal generator of claim 1, wherein the graphical image is a two dimensional image.

3. The signal generator of claim 1, wherein the graphical image is a spectral content.

4. The signal generator of claim 3, wherein the graphical display system measures an intermediate frequency of the signal generating system and displays the spectral content.

5. The signal generator of claim 3, wherein the graphical display system measures the output of the signal generating system and displays the spectral content.

6. The signal generator of claim 1, wherein the spectral content is calculated.

7. The signal generator of claim 6, wherein the spectral content is calculated from the state of the control parameter system.

8. The signal generator of claim 6, wherein the spectral content is of an intermediate frequency portion of the signal generating system.

9. A signal generator comprising:
a signal producing system having an output;
a control system controlling a state of the signal producing system; and
a graphical display system displaying a multi-dimensional graphical image associated with a radio frequency portion of the output.

10. The signal generator of claim 9, wherein the two dimensional graphical image is a calculated image of the output of the signal producing system.

11. The signal generator of claim 10, wherein the calculated image is a spectral image.

12. The signal generator of claim 11, wherein the spectral image is of the output.

13. The signal generator of claim 11, wherein the spectral image is of an intermediate frequency.

14. The signal generator of claim 9, wherein the multi-dimensional graphical image is based on a measurement of a signal of the signal generating system.

15. The signal generator of claim 14, wherein the signal is the output of the signal generating system.

16. The signal generator of claim 14, wherein the signal is an intermediate frequency of the signal generating system.

17. A signal generator comprising:
a controllable signal producing system having an output signal;
a control system controlling a state of the controllable signal producing system; and
a graphical display system displaying a measured signal on a multi-dimensional graphical image associated with the output.

18. The signal generator of claim 17, wherein the multi-dimensional image is a spectral image.

19. The signal generator of claim 17, wherein the measured signal is an intermediate frequency signal.

20. The signal generator of claim 17, wherein the measured signal is an output of a modulation system in the controllable signal producing system.
